(19) United States
(12) Patent Application Publication
(10) Pub. No.: US 2005/0207157 A1
(43) Pub. Date: Sep. 22, 2005

(54) Illumination apparatus and display apparatus using the illumination apparatus

(75) Inventor: Naoaki Tani, Hachioji-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 11/013,257

(22) Filed: Dec. 15, 2004

(30) Foreign Application Priority Data
Dec. 18, 2003 (JP) 2003-420568

(51) Int. Cl. F21V 1/00; F21V 11/00; F21V 5/00

(52) U.S. Cl. 362/244; 362/238; 362/613

(57) ABSTRACT

An illumination apparatus which illuminates an illumination object region, comprises a lighting unit which distributes the current supplied by a current supply unit to a predetermined number of the light emitting elements among a plurality of light emitting elements so that the light emitting elements are lighted, a light guide unit which has a light take-in portion, relatively moves the light take-in portion with respect to the light emitting elements, and guides the light taken in by the light take-in portion to the illumination object region, and a timing control unit which controls the lighting unit in synchronization with movement of the light take-in portion of the light guide unit. The lighting unit sequentially lights the light emitting elements positioned in the vicinity of the light take-in portion of the light guide unit every predetermined number of the elements based on control by the timing control unit.

### CROSS-REFERENCE TO RELATED APPLICATIONS

This application is based upon and claims the benefit of priority from prior Japanese Patent Application No. 2003-420568, filed Dec. 18, 2003, the entire contents of which are incorporated herein by reference.

### BACKGROUND OF THE INVENTION

1. Field of the Invention

The present invention relates to an illumination apparatus which illuminates an illumination object region, and a display apparatus using the illumination apparatus.

2. Description of the Related Art

In Jpn. Pat. Appln. KOKAI Publication No. 2001-76525, an illumination apparatus has been disclosed comprising: a plurality of light emitting elements disposed in rows and electrically classified into a plurality of groups; a light guide plate which receives light from each light emitting element and which radiates the light in a specific direction; and driving means for driving the plurality of light emitting elements by pulse signals whose phases are different and whose effective time partially overlaps.

Jpn. Pat. Appln. KOKAI Publication No. 2003-24275 discloses a light-source unit and an electronic endoscope that incorporates the light-source unit. The light-source unit has light-emitting diodes that emit light, and is able to guide efficiently the light to the distal end of the electronic endoscope. The light-source unit provided in the endoscope comprises a lamp, a motor, an LED-driving circuit and two brushes. The lamp comprises a disc and a plurality of light-emitting diodes. The light-emitting diodes are equidistantly arranged along the circumference of the disc, on that surface of the disc which opposes the light guide. As the motor rotates the disc at a constant speed, the light-emitting diodes sequentially pass the input end of the light guide, at which the brushes are provided. Every time any light-emitting diode passes the input end of the light guide, the LED-driving circuit supplies a current to the diode through the brushes. Thus, the light-emitting diodes are sequentially driven to apply light to the input end of the light guide.

In an embodiment described in the above-identified publication, the light-emitting diodes are driven, one at time, with a pulse drive current. The pulse drive current can be greater than the forward current supplied to the light-emitting diode to turn it on continuously. Moe precisely, the LED drive circuit supplies the maximum current that can be supplied to the diode, that is, supplies a current almost equal to a peak forward current, which corresponds to the duty ratio of lighting period. If the duty ratio is set to a value as small as possible within the permissible range, the peak forward current can be large, and the current supplied to the light-emitting diode can be proportionally large. Hence, the light-emitting diodes can emit high-luminance light.

Jpn. Pat. Appln. KOKAI Publication No. 10-333588 discloses an invention to provide an optical system which can guide projection lights from false successive oscillation semiconductor lasers to one optical fiber. A rotary mirror which slants in the direction wherein the projection lights from the false successive oscillation semiconductor lasers arrayed on the same circumference are guided to the end surface of an optical fiber is rotated and directed to the respective semiconductor lasers in synchronism with the oscillation of the respective semiconductor lasers made to oscillate so that false successive oscillation pulses are shifted respectively. Consequently, the oscillation lights of all the semiconductor lasers which are arrayed can be guided to the optical fiber.

Further, the publication discloses a false successive oscillation (Quasi-CW) semiconductor for alternately repeating oscillation and radiation of heat, oscillation being suspended when heat is being radiated, and for oscillating a pulse having a short form and a high peak power.

Jpn. Pat. Appln. KOKAI Publication No. 10-293233 discloses an invention to provide a backlight for a color liquid crystal display device coping with both thinning and attaining high luminance of a light transmission plate. First, second curved reflection surfaces opposite to each other in the thickness direction of the light transmission plate and a third curved reflection surface existing on an opposite light transmission plate side are respectively expanded/formed on the circumference of a rotary mirror, and light sources are arranged in respective curved reflection surfaces. Then, when the light sources in the first and second curved reflection surfaces are emitted, the rotary mirror exists on positions dividing one of the first and second curved reflection surfaces from the other curved reflection surfaces, and when the light source in the third curved reflection surface is emitted, the rotary mirror exists on the position coinciding with the light source.

Further, the publication discloses the structure of the light sources of the three primary colors emitting a pulse sequentially and periodically, and the structure of adjusting the light quantity (luminance) ratio of each light source by the output current adjustment of invertors to perform the white color adjustment of a backlight, that is, to adjust mainly the white color region adopted by the CIE (Commission Internationalde Leclairage).

U.S. 2002/0080834 A1 and Jpn. Pat. Appln. KOKAI Publication No. 2000-294491, which corresponds to the U.S. 2002/0080834 A1, disclose a light source device capable of further enhancing an effective pulse rate. A light source device disclosed in the publications comprises: a plurality of light sources emitting radiation light; a rotating reflection body having one or more reflection surfaces and emitting the radiation light emitted from the respective light sources along an optical path common to the light sources; a position detecting device detecting a position of the reflection surface of the rotating reflection body; a timing control circuit generating a synchronization signal for driving the plurality of light sources in synchronization with the position of the rotating reflection body based on an output signal from the position detecting device; and a power supply circuit sequentially pulse-driving the light sources based on an output signal from the timing control circuit.

Further, the publications disclose that a plurality of pulse lights sequentially emitted from the plurality of light sources can be sequentially emitted along a common optical path, and that pulse rate is multiplied by a multiple of the number of light sources provided. Thus, it is made possible to increase the effective pulse rate as a light source device. At the same time, together with the increase of the light emission rate of the light source device, the time-average luminance is also increased, and as a result, an effective luminance is also increased as a light source device for illumination.

U.S. 2003/0076057 A1 and Jpn. Pat. Appln. KOKAI Publication No. 2003-208991, which corresponds to the U.S. 2003/0076057 A1, disclose a device for illumination or signaling, comprising at least two light-emitting diodes that each emit a light beam and are supplied with a pulsed current so as to be lit alternately, the pulses of the supply current of the light-emitting diodes having an instantaneous intensity higher than the maximum intensity in steady state and an average intensity lower than this maximum value, the pulses of the supply current of the light-emitting diodes having a duty ratio greater than or equal to the inverse of the number of light-emitting diodes. The device comprises an optical system that receives the light beams emitted by the light-emitting diodes and delivers a single emergent beam, irrespective of which light-emitting diode is providing it with an incident beam.

U.S. 2004/0041744 A1 discloses an image display apparatus including a plurality of light emission sources, a drive circuit for pulse-driving the plurality of light emission sources in order in a predetermined period, a moving reflecting mirror for swinging in order in an incidence direction of light from each of the light emission sources in response to the pulse driving timing of each of the light emission sources and reflecting light beams from the light emission sources in order approximately in the same direction, and a combining optical system for guiding the light reflected by the moving reflecting mirror into a light valve.

### BRIEF SUMMARY OF THE INVENTION

According to a first aspect of the present invention, there is provided an illumination apparatus which illuminates an illumination object region, comprising:
a current supply unit configured to supply a current controlled into a predetermined value;
a plurality of light emitting elements configured to generate light in response to the supplied current;
a lighting unit configured to distribute the current supplied by the current supply unit to a predetermined number of the light emitting elements among the plurality of light emitting elements so that the light emitting elements are lighted;
a light guide unit having a light take-in portion, configured to relatively move the light take-in portion with respect to the light emitting elements, and configured to guide the light taken in by the light take-in portion to the illumination object region; and
a timing control unit configured to control the lighting unit in synchronization with movement of the light take-in portion of the light guide unit,
wherein the lighting unit is configured to sequentially light the light emitting elements positioned in the vicinity of the light take-in portion of the light guide unit every predetermined number of the elements based on control by the timing control unit.

According to a second aspect of the present invention, there is provided a display apparatus comprising:
an illumination apparatus which illuminates an illumination object region, including:
   a current supply unit configured to supply a current controlled into a predetermined value;
   a plurality of light emitting elements configured to generate light in response to the supplied current;
   a lighting unit configured to distribute the current supplied by the current supply unit to a predetermined number of the light emitting elements among the plurality of light emitting elements, so that the light emitting elements are lighted;
   a light guide unit having a light take-in portion, configured to relatively move the light take-in portion with respect to the light emitting elements, and configured to guide the light taken in by the light take-in portion to the illumination object region; and
   a timing control unit configured to control the lighting unit in synchronization with movement of the light take-in portion of the light guide unit, the lighting unit being configured to sequentially light the light emitting elements positioned in the vicinity of the light take-in portion of the light guide unit every predetermined number of the elements based on control by the timing control unit; and
a spatial light modulation unit which is disposed in the illumination object region and to which illumination light from the illumination apparatus is applied,
wherein the display apparatus displays an image by modulated light modulated by the spatial light modulation unit.

According to a third aspect of the present invention, there is provided an illumination apparatus which illuminates an illumination object region, comprising:
current supply means for supplying a current controlled into a predetermined value;
a plurality of light emitting elements for generating light in response to the supplied current;
lighting means for distributing the current supplied by the current supply means to a predetermined number of the light emitting elements among the plurality of light emitting elements so that the light emitting elements are lighted;
light guide means, having a light take-in portion, for relatively moving the light take-in portion with respect to the light emitting elements, and for guiding the light taken in by the light take-in portion to the illumination object region; and
timing control means for controlling the lighting means in synchronization with movement of the light take-in portion of the light guide means,
wherein the lighting means sequentially light the light emitting elements positioned in the vicinity of the light take-in portion of the light guide means every predetermined number of the elements based on control by the timing control means.

According to a fourth aspect of the present invention, there is provided a display apparatus comprising:
an illumination apparatus which illuminates an illumination object region, including:
   current supply means for supplying a current controlled into a predetermined value;
   a plurality of light emitting elements for generating light in response to the supplied current;
   lighting means for distributing the current supplied by the current supply means to a predetermined number of the light emitting elements among the plurality of light emitting elements so that the light emitting elements are lighted;
   light guide means, having a light take-in portion, for relatively moving the light take-in portion with respect to the light emitting elements, and for guiding the light taken in by the light take-in portion to the illumination object region; and
   timing control means for controlling the lighting means in synchronization with movement of the light take-in portion of the light guide means, the lighting means sequentially lighting the light emitting elements positioned in the vicinity of the light take-in portion of the light guide means every predetermined number of the elements based on control by the timing control means; and
spatial light modulation means which is disposed in the illumination object region and to which illumination light from the illumination apparatus is applied,
wherein the display apparatus displays an image by modulated light modulated by the spatial light modulation means.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a configuration of an illumination apparatus according to a first embodiment of the present invention;

FIG. 2 is a side view showing an LED light take-out structure;

FIG. 3 is a circuit diagram showing configurations of a current control circuit and a sequential lighting circuit;

FIG. 4 is a waveform diagram showing a case where LEDs are lighted one by one with respect to one take-in port;

FIG. 5 is a waveform diagram showing a case where LEDs are lighted every two LEDs with respect to one take-in port;

FIG. 6 is a waveform diagram showing a current supplied to a LED and an electric power consumption of the LED in LED lighting cycle;

FIG. 7 is a diagram showing a configuration of an illumination apparatus according to a second embodiment of the present invention;

FIG. 8 is a circuit diagram showing configurations of the current control circuit and the sequential lighting circuit;

FIG. 9 is a diagram showing a control voltage waveform and a light output waveform at the time of switching of light emitting color;

FIG. 10 is a diagram showing a configuration of the illumination apparatus according to a third embodiment of the present invention;

FIG. 11 is a circuit diagram showing configurations of the current control circuit and the sequential lighting circuit;

FIG. 12 is a diagram showing a configuration of a T-shaped light guide rod;

FIG. 13 is a diagram showing an LED lighting timing and a light output waveform in the third embodiment;

FIG. 14 is a waveform diagram showing a case where there is a light power control;

FIG. 15 is a waveform diagram showing a case where there is not any light power control;

FIG. 16 is a diagram showing a configuration of the illumination apparatus according to a fourth embodiment of the present invention;

FIG. 17 is a diagram showing a configuration of the L-shaped light guide rod for use in the illumination apparatus according to the fourth embodiment of the present invention;

FIG. 18 is a diagram showing the LED lighting timing and the light output waveform;

FIG. 19 is a diagram showing a configuration of a display apparatus according to a fifth embodiment of the present invention;

FIG. 20 is a diagram showing a configuration of a light beam shape conversion element;

FIG. 21 is a diagram showing a configuration of a display apparatus according to a sixth embodiment of the present invention; and

FIG. 22 is a diagram showing an influence of light power variation onto gradation display by pulse width modulation.

### DETAILED DESCRIPTION OF THE INVENTION

Embodiments of the present invention will be described hereinafter with reference to the drawings.

### First Embodiment

As shown in FIG. 1, an illumination apparatus according to a first embodiment of the present invention comprises: a current control circuit 10 which is a current supply unit; a plurality of LEDs 12 which are light emitting elements; a sequential lighting circuit 14 which is a lighting unit; and an PLL circuit 16 and a timing generation circuit 18 which are a timing control unit.

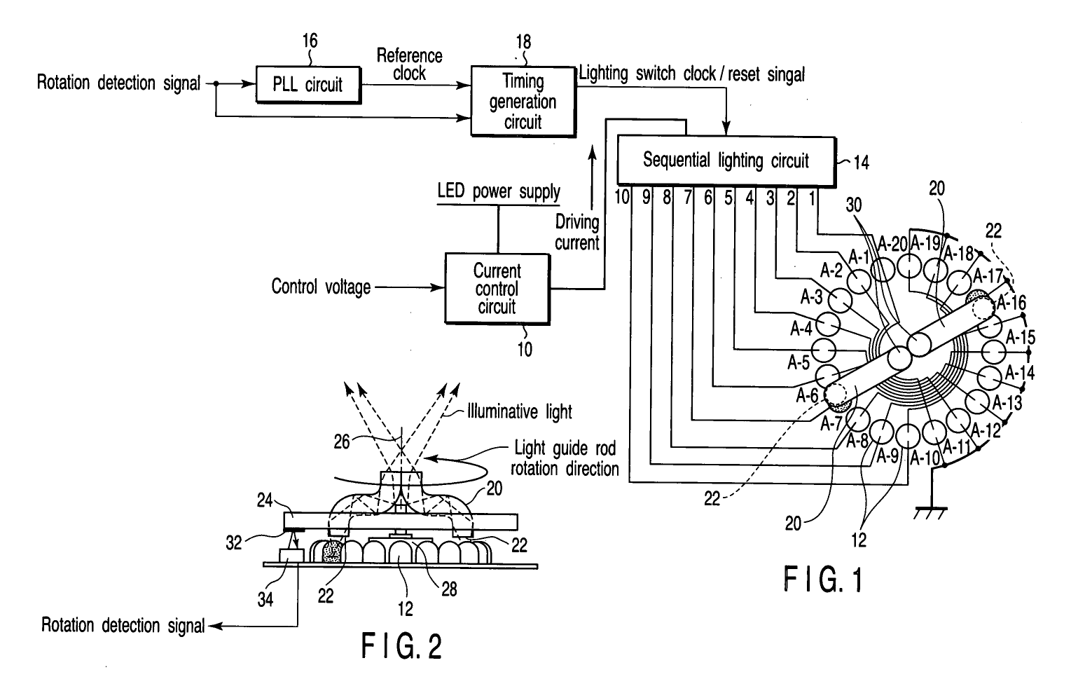

Here, as shown in FIGS. 1 and 2, the plurality of (twenty A-1 to A-20 in the present embodiment) LEDs 12 are arranged in a circular shape in such a manner as to closely contact one another, and are arranged in such a manner that the light is radiated in the same direction vertical to a surface on which the LEDs are arranged. Two S-shaped light guide rods 20 whose opposite end faces and side faces are polished and which have a solid core are arranged as light guide portions in a light radiated direction. These two light guide rods 20 are fixed to a rod holder 24 in such a manner that take-in ports 22 which are take-in portions take in the light of the LEDs 12 in facing positions on the circumference on which the rods are arranged. Moreover, these light guide rods 20 rotate at a certain rotation speed by a motor 28 using a center of a circle in which the LEDs 12 are arranged as a rotation axis 26. That is, these light guide rods 20 are configured in such a manner that the take-in ports 22 are relatively movable with respect to the LEDs 12. Furthermore, these two light guide rods 20 are attached to the rod holder 24 in such a manner that emission ports 30 are disposed adjacent to each other via the rotation axis 26.

A rotation detection mark 32 is attached to the rod holder 24. A rotation detection sensor 34 configured by, for example, a photo reflector is disposed in a predetermined position in the vicinity of the LED 12 corresponding to an attached position of the rotation detection mark 32. When the rotation detection sensor 34 detects the rotation detection mark 32, the sensor outputs a rotation detection signal in accordance with the rotation of the light guide rod 20. It is to be noted that the motor 28 is driven in such a manner as to rotate at a certain rotation speed by a motor driving circuit (not shown).

The rotation detection signal output from the rotation detection sensor 34 is input into the PLL circuit 16 and the timing generation circuit 18. The PLL circuit 16 generates a reference clock synchronized with rotation of the light guide rods 20 by the input rotation detection signal, and supplies the reference clock to the timing generation circuit 18. The timing generation circuit 18 produces a reset signal and a lighting switch clock which compensate for a shift between the position of the take-in port 22 of the light guide rod 20 and the lighting position of the LED 12 from the input reference clock and the rotation detection signal, and controls the sequential lighting circuit 14 by the reset signal and the lighting switch clock.

The sequential lighting circuit 14 has ten driving lines (1 to 10) connected to the LEDs 12, and each driving line is connected to two LEDs 12 in series like A-1 and A-11, A-2 and A-12. Additionally, in this case, two LEDs 12 connected to the same driving line are disposed on the opposite side of a circumference on which the LEDs 12 are arranged. Therefore, when a driving current flows through one driving line, two LEDs 12 corresponding to two take-in ports 22 simultaneously light. The driving current selectively supplied to each LED 12 from the sequential lighting circuit 14 is controlled and set to a predetermined value by the current control circuit 10.

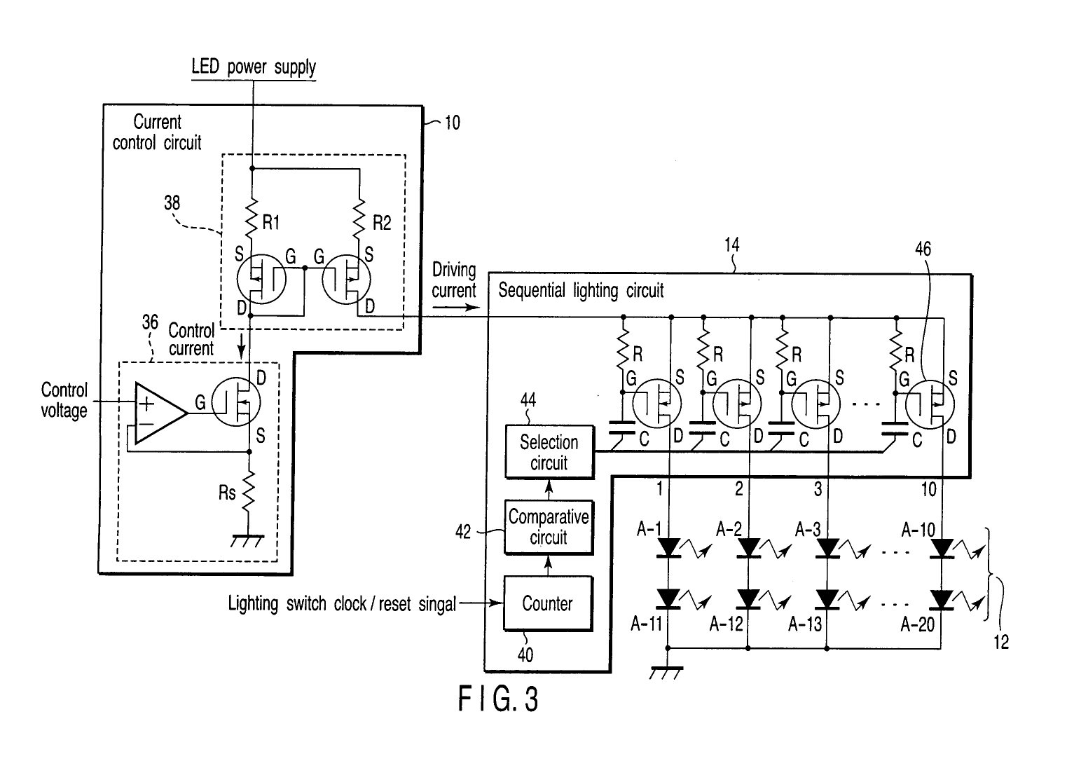

That is, as shown in FIG. 3, the current control circuit 10 comprises a constant current circuit 36 and a current mirror circuit 38. Here, since the constant current circuit 36 feedback-controls a control current flowing in a current detection resistance Rs, the circuit produces a control current proportional to the input control voltage. This control voltage will be described later. The current mirror circuit 38 is connected to an LED power supply, produces a current amplified in accordance with settings of a resistance R1 on a control side and a resistance R2 on a controlled side, and outputs the produced current as a driving current to be supplied to the sequential lighting circuit 14.

On the other hand, the sequential lighting circuit 14 comprises a counter 40, a comparative circuit 42, a selection circuit 44, and switching FETs 46 connected to driving lines. That is, in the sequential lighting circuit 14, the counter 40 operates in response to a reset signal and a lighting switch clock supplied from the timing generation circuit 18. The comparative circuit 42 compares a count value of the counter 40 with a value determined to be sequentially lighted beforehand. Based on the result, the selection circuit 44 outputs a pulse to the switching FET 46 corresponding to the LEDs 12 to be lighted in accordance with a lighting period. In this case, the driving current from the current control circuit 10 can be supplied to the driving line connected to the LEDs 12 positioned in the vicinity of the take-in port 22.

It is to be noted that a gate of the switching FET 46 is connected to a resistance R and a capacitor C. Even when this RC circuit is disposed, the pulse from the selection circuit 44 is transmitted in accordance with a lighting period. When a constantly lighting voltage is supplied to the switching FET 46 by a trouble of the selection circuit 44 or the like, the FET can be turned off in a certain period due to the RC circuit. Therefore, the LED 12 can be prevented from being continued to light.

As described above, each driving line is connected to two LEDs 12 in series. Therefore, when the current is supplied to each driving line, a driving current flows through two LEDs 12 connected in series to the driving line. Accordingly, these two LEDs 12 radiate the light having an intensity in accordance with the driving current toward the take-in ports 22 of the light guide rods 20. The light of the LED 12 is taken in from the take-in port 22 of the light guide rod 20, as shown in FIG. 2. Moreover, the taken-in light repeats reflection on the side surface of the light guide rod 20, and the light is transmitted to the emission port 30, and emitted as illumination light constantly from the vicinity of the rotation axis 26.

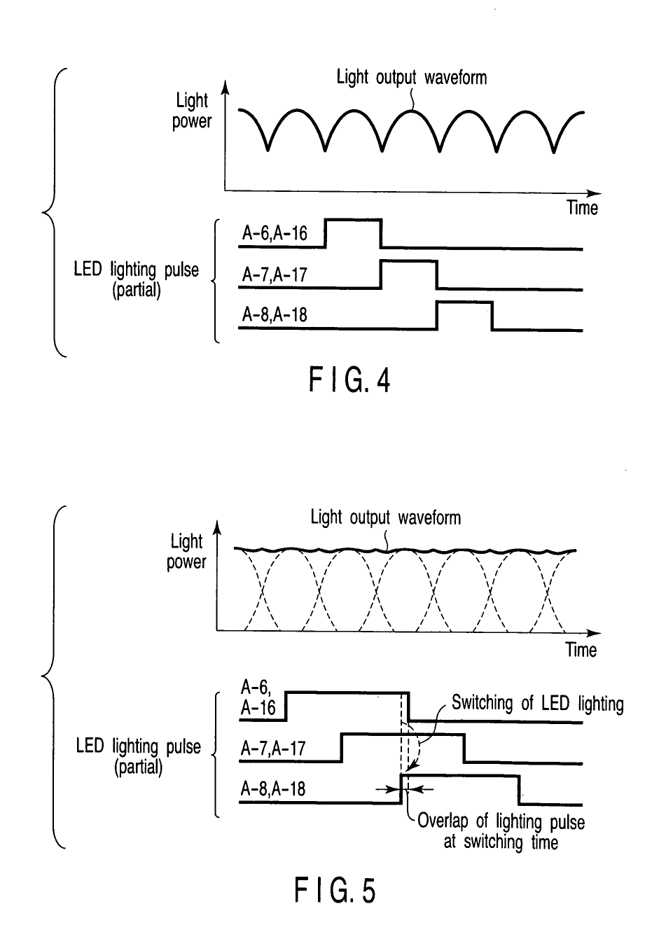

The sequential lighting circuit 14 sequentially selects each driving line, and lights the LEDs 12 one by one with respect to each take-in port 22 in synchronization with rotation of the take-in ports 22 of the light guide rod 20. In this case, a quantity of light taken into the light guide rod 20 changes with a positional relation between the lighting LED 12 and the take-in ports 22 of the light guide rod 20. Therefore, the illumination light emitted from the emission port 30 of the light guide rod 20 is continuous light having a variance component as shown by a light output waveform shown in FIG. 4.

On the other hand, in the above-described sequential lighting circuit 14, a predetermined value of the comparative circuit 42 or inner configuration of the selection circuit 44 is changed, and accordingly the number of simultaneously selected driving lines can be changed. Then, for example, the driving current for two driving lines is supplied from the current control circuit 10, the sequential lighting circuit 14 selects two driving lines, and two LEDs 12 constantly adjacent to one take-in port 22 may emit the light while overlapping thire lighting periods. In this case, a change of a take-in light power accompanying the movement of the take-in ports 22 is a change shown by a broken line in FIG. 5 with respect to one LED 12. That is, the take-in light power from the adjacent LEDs 12 increases in accordance with the decrease of the take-in light power from the one LED 12 and, as a result, the light output waveform of the emitted light having little light power variance is obtained.

It is to be noted that a slight overlap is disposed in the lighting pulse at a switching time for the following reasons. That is, when the overlap is not disposed, for example, in FIG. 5, a moment in which both the LED lighting pulse of A-6, A-16 and the LED lighting pulse of A-8, A-18 are off is generated. However, even at this time, the driving current for two driving lines are output from the current control circuit 10. Therefore, the driving current for two lines flow through LEDs 12 of A-7, A-17 which turn on. Therefore, the driving current for two lines momentarily flow through three driving lines in order to protect the LEDs.

When the driving current is distributed to a plurality of driving lines in this manner, the light power variance can be reduced. Additionally, when dispersion of the quality of the LED 12 is large, or a plurality of types of LEDs 12 are used, a difference is made in an electric characteristic such as a forward voltage. Therefore, in this case, when the driving current is simultaneously distributed to the plurality of driving lines from the current control circuit 10, there is a possibility that a non-controllable difference is generated in the driving currents of the individual driving lines, and it is therefore preferable not to distribute the current.

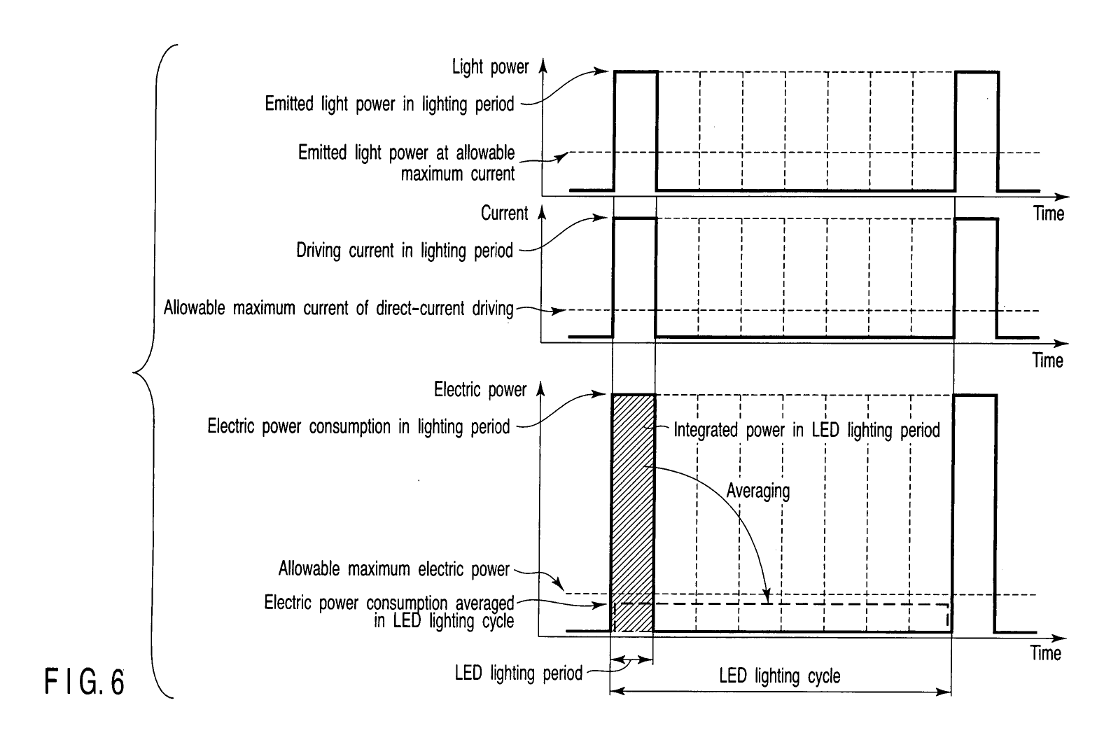

Additionally, as the control voltage to be supplied to the constant current circuit 36 of the current control circuit 10, a current larger than an allowable maximum current at the time of direct-current lighting of the LED 12 is adjusted to be supplied to the LEDs 12 connected to each driving line via the sequential lighting circuit 14. That is, in FIG. 6, an integrated electric power in an LED lighting period is shown in a hatching region. An electric power averaged in an LED lighting cycle is a region surrounded with a thick broken line, and a height of this region indicates electric power consumption averaged in the LED lighting cycle. The number of the LEDs 12 connected to the sequential lighting circuit 14, and the lighting cycle of the LED 12 are set in such a manner that the electric power consumption averaged in the LED lighting period is smaller than the allowable maximum power of the LED 12. As a result, the emitted light power in the lighting period of each LED 12 is larger than that driven at an allowable maximum current.

According to the above-described first embodiment, the LEDs 12 positioned in the vicinity of the take-in ports 22 are sequentially lighted every predetermined number of the LEDs in synchronization with the movement of the take-in ports 22. Therefore, without lighting extra LEDs 12 with respect to the moving take-in ports 22, the light guide rods 20 can take in the light with good efficiency. The illumination light can be taken out of a region which has an area smaller than that occupied by the plurality of LEDs 12 and in which the emission ports 30 of the light guide rods 20 in the vicinity of the rotation axis 26 rotate. Therefore, illumination is possible with good efficiency with respect to an object to be illuminated, having a small area and having a small allowable incident light angle. Furthermore, the emitted light power of each LED 12 can be momentarily increased, the light guide rod 20 continuously takes in the light of the lighting LED 12, and therefore the illumination light having a larger light power can be obtained. The current control circuit 10 can be miniaturized and easily configured in order to light the predetermined number of the LEDs 12 by the distributed current among the plurality of LEDs 12 connected to the common current control circuit 10.

It is to be noted that two LEDs 12 connected to one driving line may be connected in parallel. Furthermore, the number of the LEDs 12 connected to one driving line is not limited to two, one LED may be connected, and more LEDs 12 may be connected by combination of series and parallel connections. The driving line is switched by the switching FET 46, but transistors may be disposed instead of the FETs.

### Second Embodiment

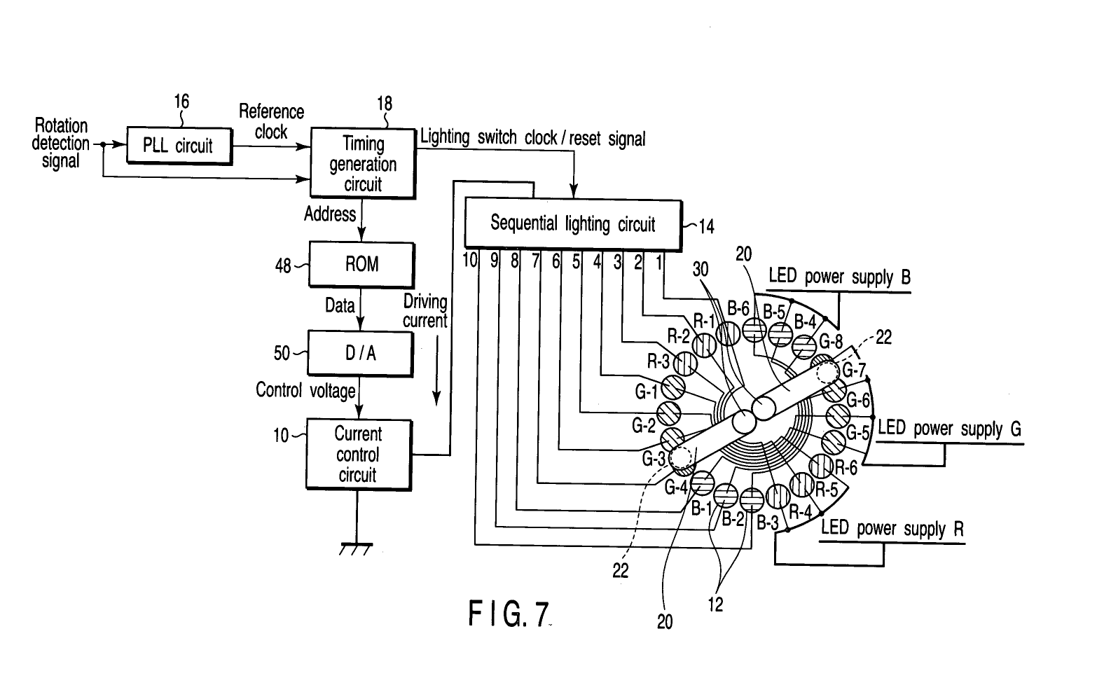

As shown in FIG. 7, in the same manner as in the illumination apparatus according to the first embodiment, an illumination apparatus according to a second embodiment of the present invention comprises: a current control circuit 10 which is a current supply unit; a plurality of LEDs 12 which are light emitting elements; a sequential lighting circuit 14 which is a lighting unit; and an PLL circuit 16 and a timing generation circuit 18 which are a timing control unit. Furthermore, in the present embodiment, the apparatus comprises a ROM 48 and a D/A converter 50 which are light power control units.

Moreover, arrangement of the LEDs 12, mechanical configurations of light guide rods 20 and the like are also the same as those of the first embodiment. Additionally, in the present embodiment, one sequential lighting circuit 14 is connected to three types R, G, B of LEDs 12 which have different emitted light colors and electric characteristics. Here, each driving line of the sequential lighting circuit 14 is connected in series to two LEDs 12 of the same color like R-1 and R-4, R-2 and R-5, . . . , B-3 and B-6. In this case, the LED 12 is connected to the sequential lighting circuit 14 on a cathode side, the LEDs 12 of the same color are connected to each other on an anode side, and the LEDs are connected to LED power supplies R, G, B disposed for the respective colors. It is to be noted that in FIG. 7, hatching applied to the LED 12 indicates a color difference, and does not show a cross-section (this also applies to the drawings for use in the description of the following embodiments).

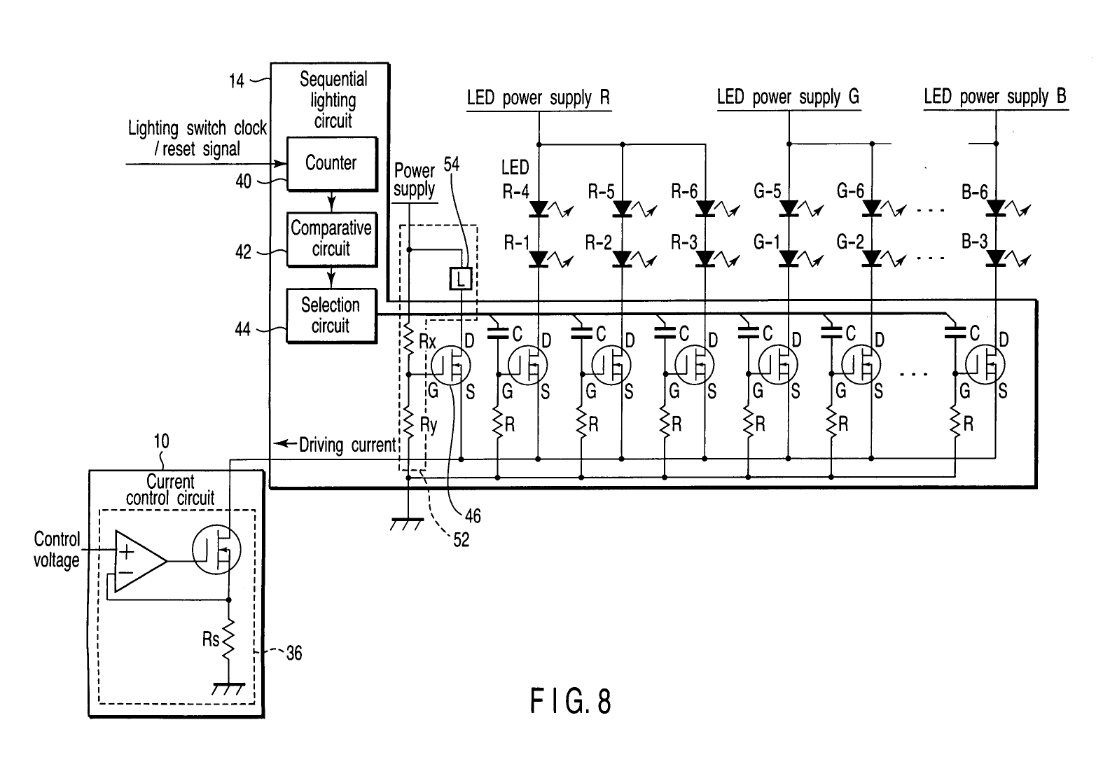

FIG. 8 is a diagram showing configurations of the current control circuit 10 and the sequential lighting circuit 14 in the present embodiment. In the present embodiment, the current control circuit 10 comprises an only constant current circuit 36. This constant current circuit 36 feedback-controls a control current flowing through a current detection resistance Rs, and therefore produces a control current proportional to an input control voltage.

Moreover, the sequential lighting circuit 14 comprises a counter 40, a comparative circuit 42, a selection circuit 44, and switching FETs 46 connected to driving lines and one dummy circuit 52. Here, the dummy circuit 52 has a dummy load 54 such as an LED, diode, resistance or the like. A fixed voltage determined by values of resistances Rx, Ry is applied to a gate of the switching FET 46 connected to the dummy circuit 52. Therefore, even when all the switching FETs 46 connected to the LEDs 12 are turned off, the switching FET 46 connected to the dummy circuit 52 is brought into an on-state, and a driving current flows through the dummy circuit 52 having the dummy load 54. Accordingly, a current constantly flows a current detection resistance Rs of the current control circuit 10, and a feedback control of the current control circuit 10 can be kept in a constantly stable state. It is to be noted that since operations of the counter 40, comparative circuit 42, selection circuit 44 are similar to those of the first embodiment, description is omitted.

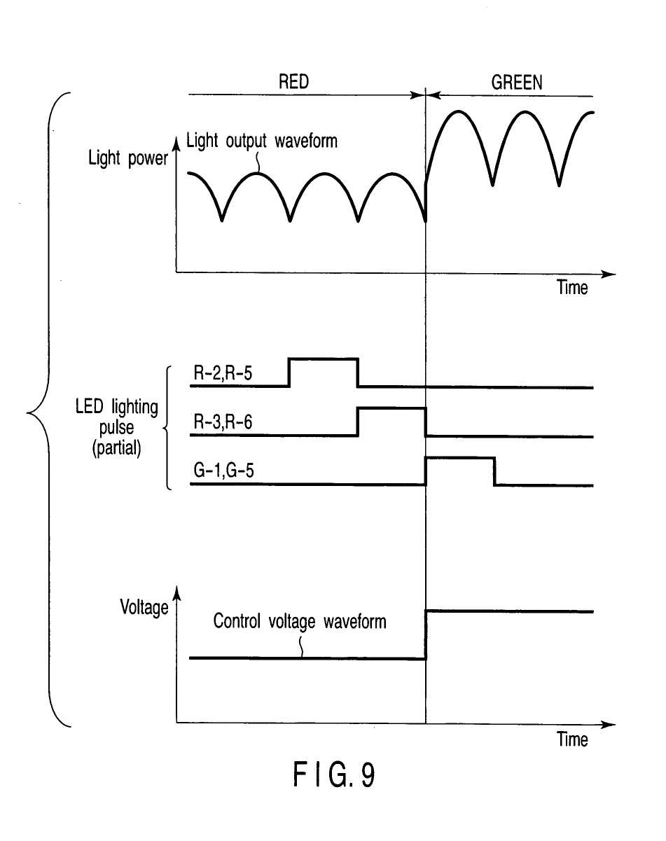

The ROM 48 receives address setting which differs in accordance with the LED 12 of each color from the timing generation circuit 18, and outputs data written beforehand in the different addresses to the D/A converter 50. The D/A converter 50 converts the data to a control voltage and outputs it to the current control circuit 10. It is to be noted that in the present embodiment, with regard to a control voltage waveform at an emitted light color switching time, for example, as shown in FIG. 9, the control voltage is switched by the data of the ROM 48 in synchronization with the emitted light color switching, and the light power is switched for each emitted light color.

According to the second embodiment, even when the LEDs 12 having different emitted light colors have differences in the electric characteristics, the current can be supplied to the LEDs 12 by the common current control circuit 10, and therefore the circuit or the apparatus can be miniaturized. Moreover, one illumination apparatus is capable of outputting illumination light whose color changes with time, a visual effect is therefore obtained as illumination light, and the apparatus is usable as a light source of a display apparatus which performs color display by a field sequential system. Furthermore, a light power can be independently set with respect to each emitted light color by the light power control unit comprising the ROM 48 and D/A converter 50, and therefore color balance of illumination light whose colors are mixed with time can be freely changed.

### Third Embodiment

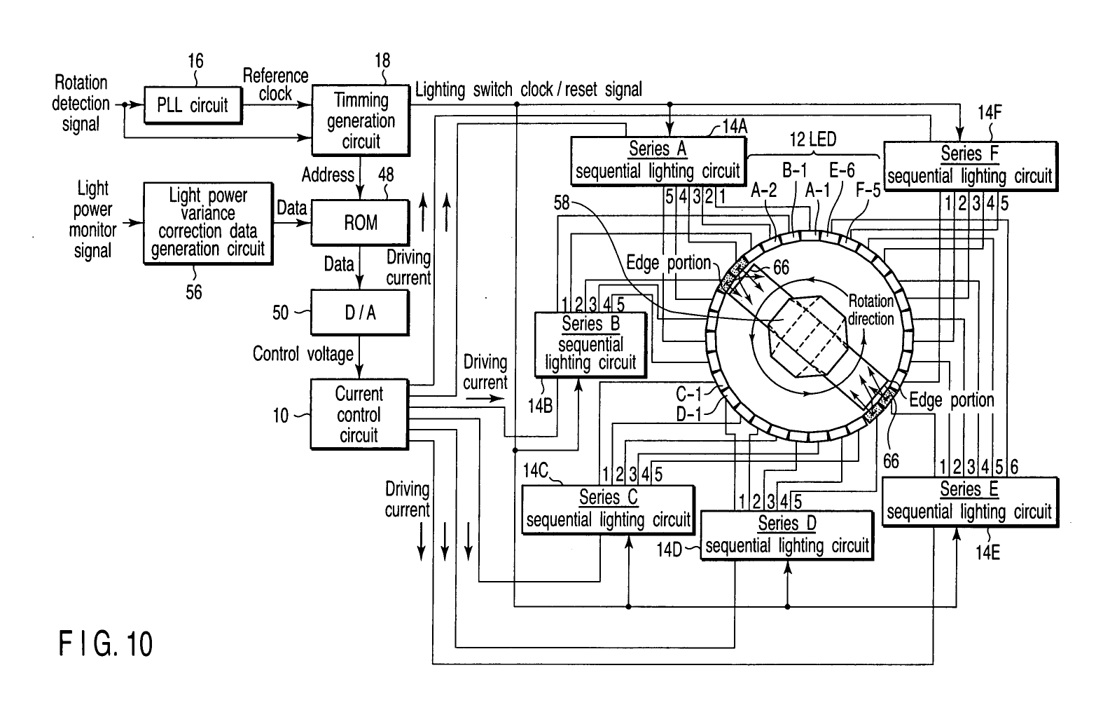

As shown in FIG. 10, in the same manner as in the illumination apparatus according to the first embodiment, an illumination apparatus according to a third embodiment of the present invention comprises: a current control circuit 10 which is a current supply unit; a plurality of LEDs 12 which are light emitting elements; a plurality of sequential lighting circuits 14 (series A sequential lighting circuit 14A to series F sequential lighting circuit 14F) which are lighting units; and an PLL circuit 16 and a timing generation circuit 18 which are a timing control unit. Furthermore, also in the present embodiment, the apparatus comprises a light power control unit in the same manner as in the second embodiment. The light power control unit of the present embodiment comprises: a light power variance correction data generation circuit 56; a ROM 48 (additionally, in the present embodiment, a rewritable ROM such as an EEPROM or a flash memory); a D/A converter 50; and the current control circuit 10 configured of a constant current circuit 36 and a current mirror circuit 38.

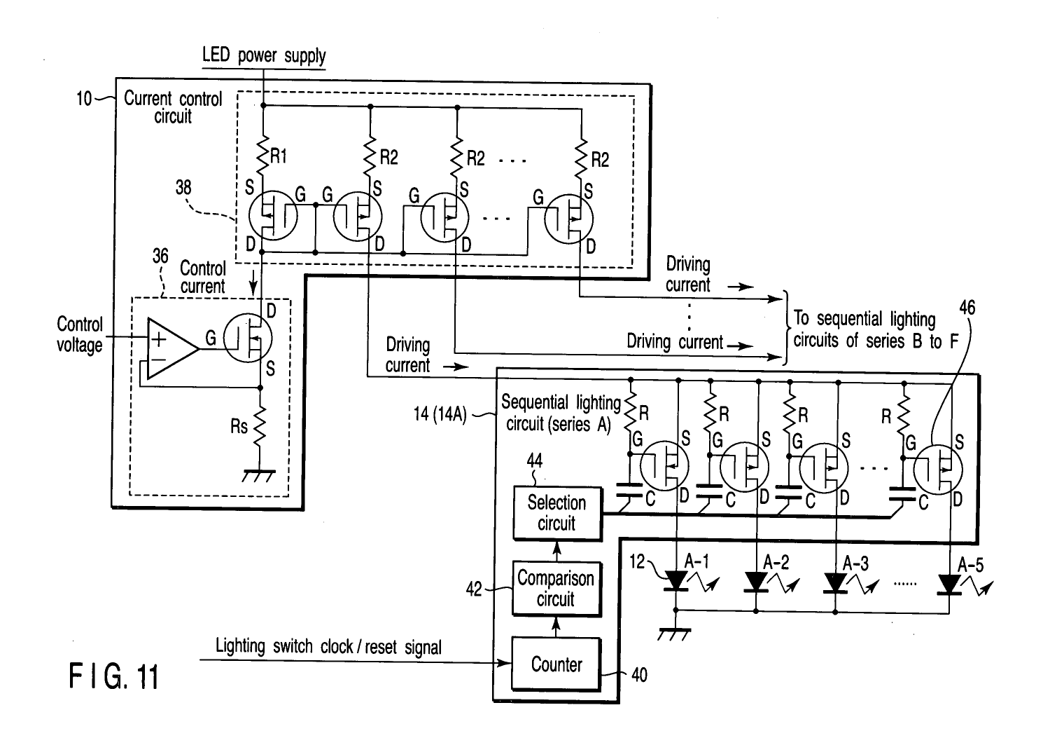

Here, the configuration of the current control circuit 10 is similar to that of the first embodiment, but, as shown in FIG. 11, the current mirror circuit 38 is divided into a plurality of circuits on a controlled side, and each circuit functions as a current supply unit of each series. That is, the current mirror circuit 38 supplies an equal driving current substantially proportional to a control current flowing on a control side to six sequential lighting circuits 14 (14A to 14F) of series A to F connected to the respective circuits on the controlled side.

The driving line of each series is connected to five or six LEDs 12. Moreover, the LEDs 12 of the series A and B, C and D, E and F are alternately arranged, and 31 LEDs 12 in total are arranged in a circular form while light emitting faces are disposed toward the inside of the circle. The LEDs 12 are alternately arranged in such a manner that the LEDs of the same series are not arranged side by side.

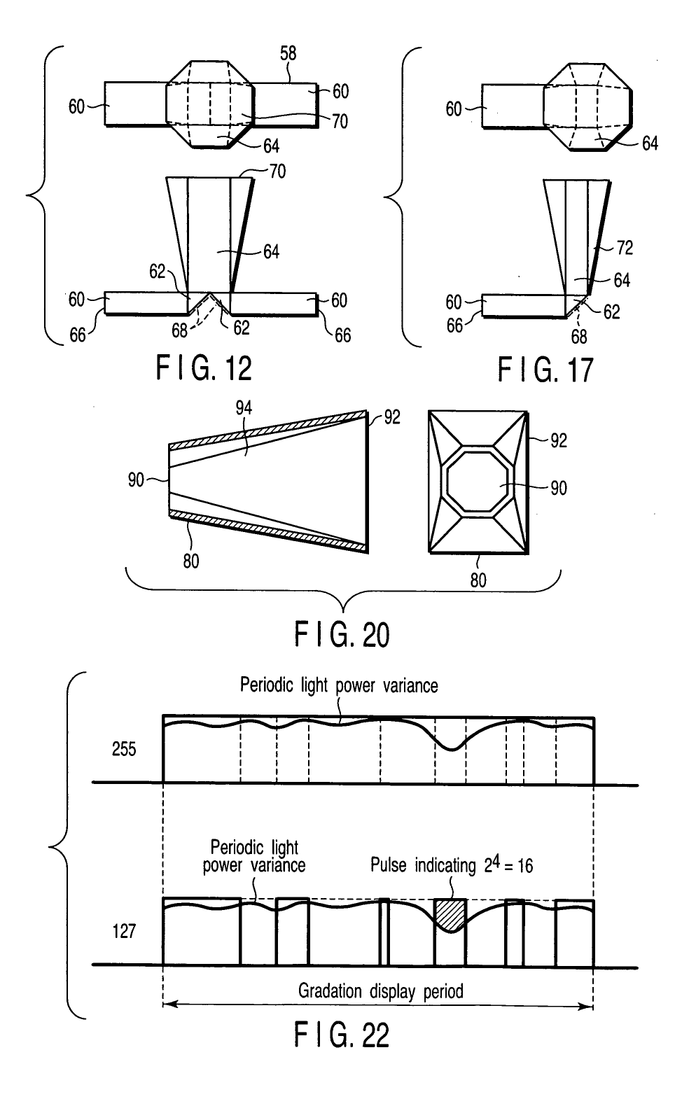

A T-shaped light guide rod 58 shown in FIG. 12 is disposed inside the LED 12 disposed in this manner. This T-shaped light guide rod 58 comprises two parallel rods 60, two high-refractive-index reflective prisms 62, and one shape conversion taper rod 64. That is, in this T-shaped light guide rod 58, light taken in from opposite light take-in ports 66 is repeatedly totally reflected by the side surfaces of the parallel rods 60, guided, and strikes on the high-refractive-index reflective prisms 62 having refractive indexes higher than those of the parallel rods 60 and shape conversion taper rod 64. Moreover, the light is reflected by reflective coatings 68 of 45-degree reflecting faces of the high-refractive-index reflective prisms 62, enters the shape conversion taper rod 64, and exists as illumination light from an octagonal output end 70 of the shape conversion taper rod 64.

The high-refractive-index reflective prisms 62 are formed of glass materials having refractive indexes higher than those of the parallel rods 60 and the shape conversion taper rod 64. Therefore, light which strikes directly on the side surface of the shape conversion taper rod 64 from the parallel rod 60 or which is reflected by the reflective surface of the high-refractive-index reflective prism 62 and thereafter strikes on the side surface of the parallel rod 60 is prevented from being leaked to the outside by total reflection of bonded interfaces. The shape conversion taper rod 64 has a quadrangular shape on an incidence side and an octagonal shape on an emission side, and an area of the rod is enlarged. The illumination light having a small spread of a radiation angle is obtained from the output end 70.

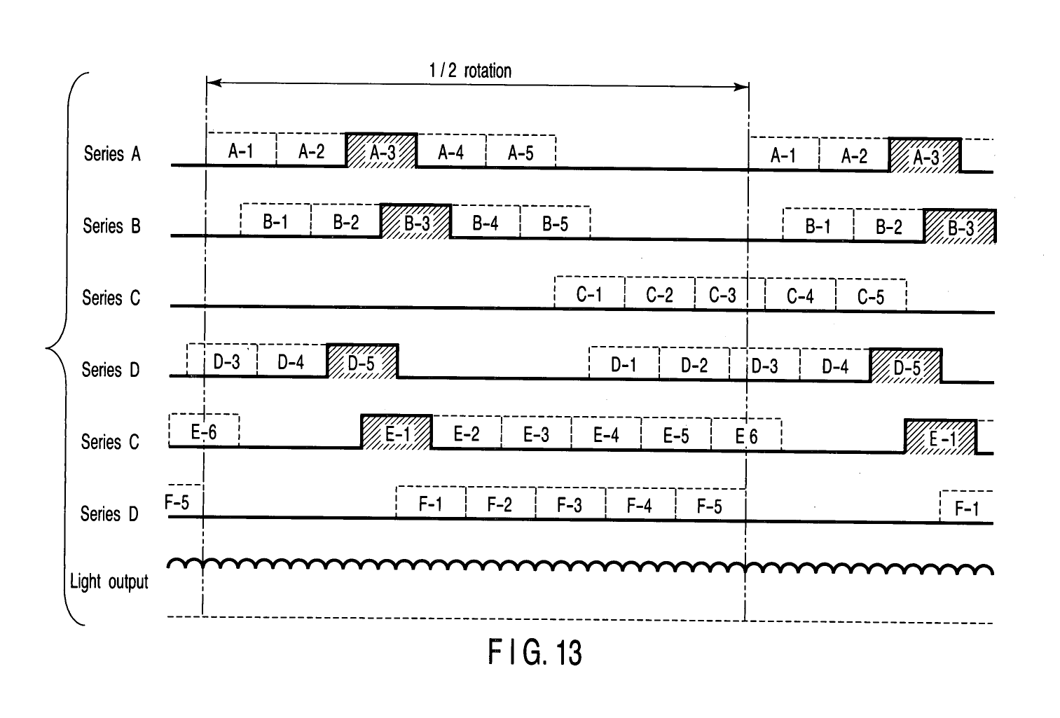

Here, each of the light take-in ports 66 has a width for two LEDs. As shown in FIG. 13, the LEDs 12 of each series are lighted one by one in order, and four LEDs 12 in total are simultaneously lighted. Each series has a resting period in which the LEDs 12 of the series are not lighted. Two LEDs 12 shift a switching timing every ½ of the lighting period with respect to the light take-in port 66 on one side. Furthermore, an odd number of LEDs 12 are arranged, and the switching timing is shifted by ¼ of the lighting period in the opposite light take-in ports 66. Therefore, as shown in FIG. 13, the light output waveform of the illumination light has four peaks in one LED lighting period, and light power variance is comparatively small.

Moreover, in the present embodiment, correction data of the light power variance is prepared when necessary, for example, at a power turn-on time, or when it is judged that the light power variance is increasing. That is, the light power variance correction data generation circuit 56 produces correction data for correcting the light power variance into a desired pattern from a light power monitor signal from a light power monitor sensor (not shown) of the illumination light, and outputs the correction data to the ROM 48. The ROM 48 stores the correction data from the light power variance correction data generation circuit 56 in a region whose address is set by the timing generation circuit 18.

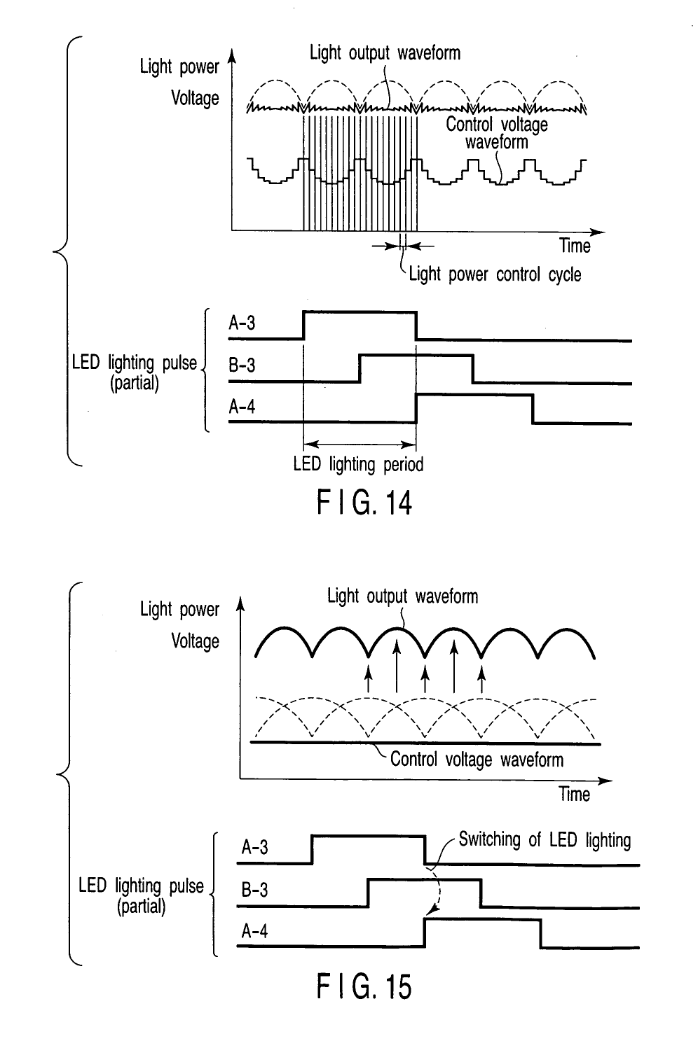

When the correction data preparation is completed, the data of the region whose address has been set by the timing generation circuit 18 is output to the D/A converter 50 from the ROM 48, and the control voltage to be supplied to the current control circuit 10 is varied in accordance with the rotation of the light guide rod 20. Accordingly, the driving current of the LED 12 to be lighted is controlled together. In this manner, the light power of the illumination light is controlled. In the light power control, as shown in FIG. 14, the control voltage is varied in a period shorter than the lighting period of one LED 12 to thereby control the driving current. Accordingly, a variance width of the light output waveform of the illumination light is suppressed to be smaller than that in a case where there is not any light power control as shown in FIG. 15.

According to the above-described embodiment, the current supply unit of each series by the current control circuit 10 can share a time to supply the current, therefore an average power loss or an average supply power of the current supply unit can be reduced, and the current supply unit is easily designed. Furthermore, since a continuous supply time of the current can be shortened in the current supply unit of each series, a drop of an output characteristic by heat generated in the continuous supply time of the current supply unit can be reduced, and the current supply unit is further easily designed. Since the LEDs 12 arranged adjacent to each other and belonging to different series are lighted in such a manner as to overlap the lighting period, the light power variance of the illumination light accompanying the movement of the light take-in port 66 can be reduced. Furthermore, since the current to be supplied to the LEDs 12 can be adjusted in synchronization with the movement of the light take-in ports 66, the quantity of the illumination light can be controlled in accordance with the movement of the light take-in port 66. Emitted light power fluctuations of the plurality of LEDs 12, and light power variance by the movement of the light take-in port 66 can be suppressed. Furthermore, the quantity of the illumination light with the movement of the light take-in ports 66 can be more finely controlled.

### Fourth Embodiment

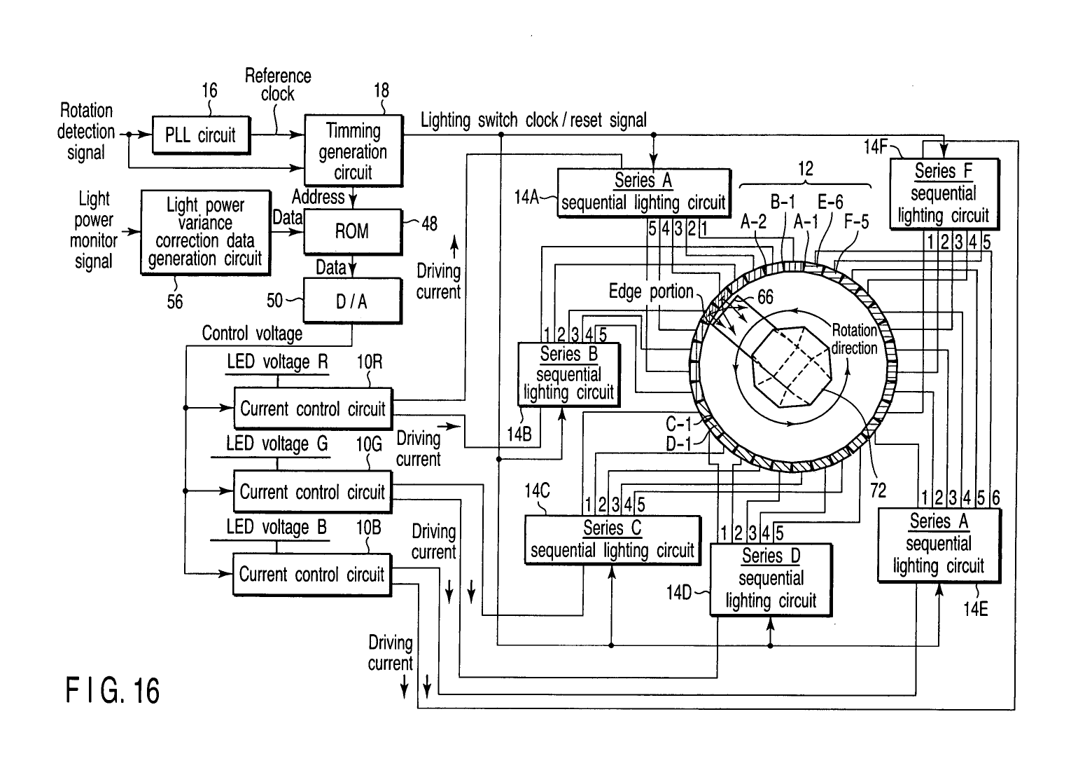

As shown in FIG. 16, in an illumination apparatus according to a fourth embodiment of the present invention, emitted light colors of LEDs 12 of series A and B, C and D, E and F in the illumination apparatus of the third embodiment are set to R, G, B, respectively. Moreover, in the present embodiment, instead of the T-shaped light guide rod 58, an L-shaped light guide rod 72 having one light take-in port 66 as shown in FIG. 17 is used. The current control circuit 10 is divided into circuits of the series A and B, C and D, E and F, and a power supply is disposed in accordance with the emitted light color of the LED 12 in each current mirror circuit 38. That is, a current control circuit 10R for R, a current control circuit 10G for G, a current control circuit 10B for B are configured.

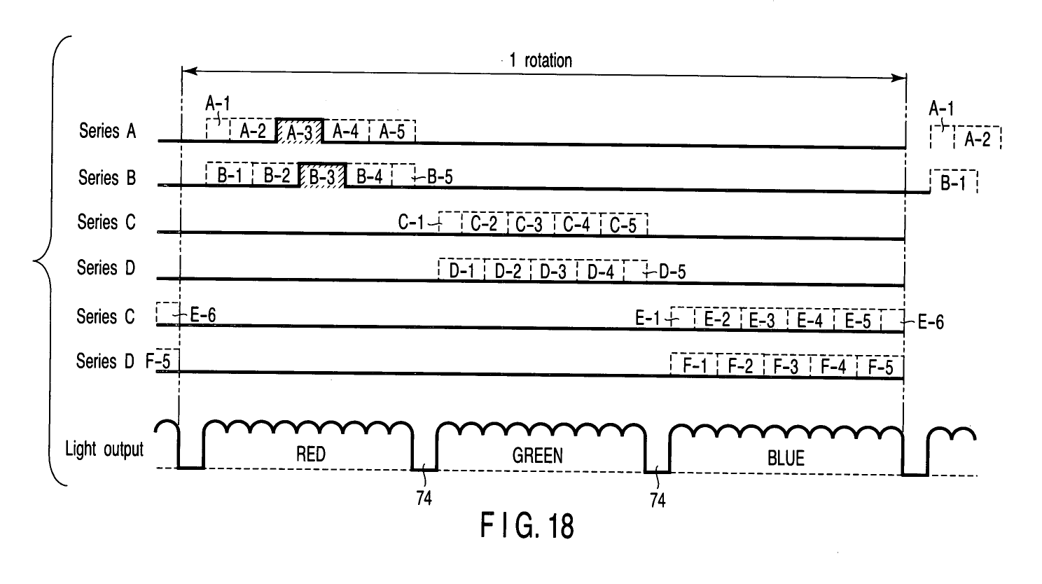

As to lighting timings in the illumination apparatus constitute in this manner according to the present embodiment, as shown in FIG. 18, non-lighting periods 74 in which all the LEDs 12 are off are disposed among the series A and B, C and D, E and F. Accordingly, two colors of light do not simultaneously enter the light take-in port 66 of the L-shaped light guide rod 72, and a light output of illumination light is set to be substantially constant in a period of each emitted light color. Since the non-lighting periods 74 are disposed, disagreement of the driving current can be prevented in a case where the LEDs 12 having different emitted light colors are simultaneously lighted, the control voltage can be common, and the circuit can be simplified.

It is to be noted that the light power control unit may be disposed for each color. In this case, the non-lighting periods 74 do not have to be set, and brighter illumination light can be obtained.

According to the present embodiment described above, even when the LEDs 12 having different emitted light colors have different electric characteristics, different types of power supplies can be connected for each emitted light color, and heat generation by power loss in the current supply unit or the lighting unit can be minimized. Moreover, the illumination light whose color changes with time can be output from one illumination apparatus, therefore a visual effect of the illumination light is obtained, and the apparatus is usable as a light source of a display apparatus which performs color display by a field sequential system. Furthermore, an independent current can be easily set for each emitted light color, and color balance of the illumination light whose colors are mixed with time can be freely changed.

### Fifth Embodiment

Next, a display apparatus using the illumination apparatus of the present invention will be described as a fifth embodiment of the present invention.

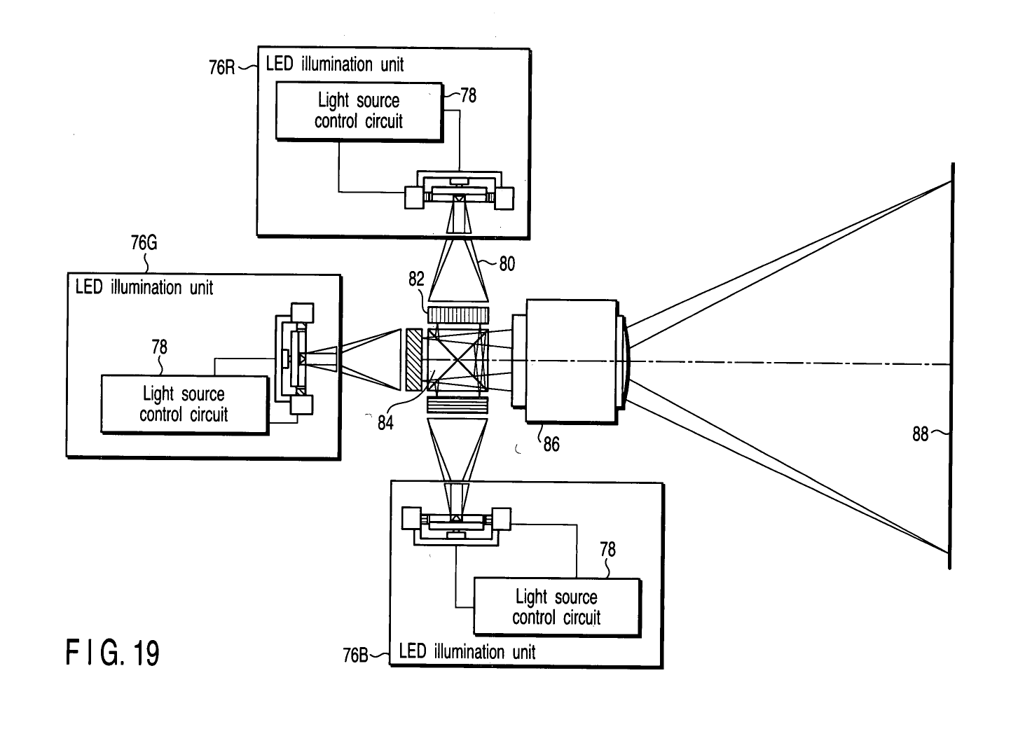

In the display apparatus according to the present embodiment, as shown in FIG. 19, LED illumination units 76R, 76G, 76B configuring the illumination apparatuses according to the first or third embodiment, and emitting single-color illumination light are used. Here, a light source control circuit 78 in each of the LED illumination units 76R, 76G, 76B includes the current control circuit 10, sequential lighting circuit 14, PLL circuit 16, and timing generation circuit 18 of the first embodiment. Alternatively, the circuit includes the current control circuit 10, sequential lighting circuits 14A to 14F, PLL circuit 16, timing generation circuit 18, ROM 48, D/A converter 50, and light power variance correction data generation circuit 56 of the third embodiment.

The illumination light emitted from each of the LED illumination units 76R, 76G, 76B is allowed to illuminate an LCD panel 82 of each color which is a spatial light modulation unit through a light beam shape conversion element 80. Moreover, modulated light which is modulated by the LCD panel 82 in accordance with display data is color-synthesized by an X prism 84 in which dichroic films are combined, and projected onto a screen 88 by a projection lens 86.

It is to be noted that, as shown in FIG. 20, the light beam shape conversion element 80 is a hollow element having an octagonal input end 90, and an output end 92 has a size and aspect substantially equal to those of the LCD panel 82. The inner surface of the light beam shape conversion element 80 is coated with a reflective coating 94.

According to the present embodiment, a display apparatus having a high light use efficiency can be realized.

### Sixth Embodiment

Next, another example of a display apparatus using the illumination apparatus of the present invention will be described as a sixth embodiment of the present invention.

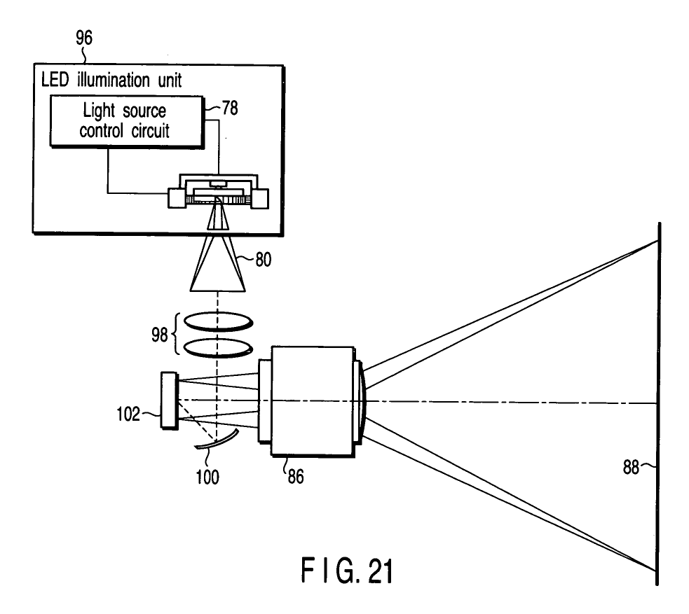

In the display apparatus according to the present embodiment, as shown in FIG. 21, an LED illumination unit 96 configuring the illumination apparatus of the second or fourth embodiment, and successively emitting RGB light as illumination light is used. Here, a light source control circuit 78 in the LED illumination unit 96 includes the current control circuit 10, sequential lighting circuit 14, PLL circuit 16, timing generation circuit 18, ROM 48, and D/A converter 50 of the second embodiment. Alternatively, the circuit includes the current control circuits 10R, 10G, 10B, sequential lighting circuits 14A to 14F, PLL circuit 16, timing generation circuit 18, ROM 48, D/A converter 50, and light power variance correction data generation circuit 56 of the fourth embodiment.

RGB field sequential illumination light emitted from the LED illumination unit 96 is reflected by an illumination mirror 100 through a light beam shape conversion element 80 and illumination lenses 98. Moreover, the light is applied into a spatial light modulation element which displays gradation by modulation of a pulse width, for example, a digital micromirror device (DMD: registered trademark of U.S. Texas Instruments Co.) 102. The modulated light space-modulated by the DMD 102 in accordance with display data is projected onto a screen 88 by a projection lens 86. It is to be noted that since details of the DMD are described, for example, in U.S. 2002/0024637 A1 or U.S. 2002/0180939 A1, description thereof is omitted here.

As to influence of light power variance on gradation display of pulse width modulation, as shown in FIG. 22, a light component indicating 2⁴ comes short, for example, if a large light power variance is generated every time with respect to a pulse indicating 2⁴=16 among 256 gradations. Therefore, the gradation of the light modulated with respect to a gradation input of a spatial light modulation element does not smoothly change, or a reverse phenomenon of the gradation occurs.

On the other hand, since the LED illumination unit 96 of the present embodiment controls the light power as described with reference to FIG. 14, the influence onto the gradation display is removed.

According to the present embodiment, a display apparatus having high light use efficiency can be realized. The illumination light having a substantially constant light power which has been finely controlled can be applied to the spatial light modulation element, and therefore an image can be displayed by correct gradation representation.

The present invention has been described based on the above-described embodiments, but the present invention is not limited to the above-described embodiments, and, needless to say, various modifications or applications are possible within the scope of the present invention. For example, the display apparatus by the illumination apparatus of the present invention is applied to a configuring part for projecting the image in a color copying machine, color printer, rewritable electronic paper recording apparatus or the like, and accordingly image forming means can be configured whose color is easily adjusted and which is therefore effective.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. An illumination apparatus which illuminates an illumination object region, comprising:
a current supply unit configured to supply a current controlled into a predetermined value;
a plurality of light emitting elements configured to generate light in response to the supplied current;
a lighting unit configured to distribute the current supplied by the current supply unit to a predetermined number of the light emitting elements among the plurality of light emitting elements so that the light emitting elements are lighted;
a light guide unit having a light take-in portion, configured to relatively move the light take-in portion with respect to the light emitting elements, and configured to guide the light taken in by the light take-in portion to the illumination object region; and
a timing control unit configured to control the lighting unit in synchronization with movement of the light take-in portion of the light guide unit,
wherein the lighting unit is configured to sequentially light the light emitting elements positioned in the vicinity of the light take-in portion of the light guide unit every predetermined number of the elements based on control by the timing control unit.

2. The illumination apparatus according to claim 1, wherein
the plurality of light emitting elements are arranged on a circumference, and
the light take-in portion of the light guide unit is configured to relatively rotate and move along the circumference.

3. The illumination apparatus according to claim 1, wherein
the light guide unit has a plurality of light take-in portions,
the number of the light emitting elements lighted at the same timing by the lighting unit is equal to that of the plurality of light take-in portions, and
the timing control unit is configured to control the plurality of light emitting elements in such a manner as to light them at the same timing in synchronization with movement of the plurality of light take-in portions.

4. The illumination apparatus according to claim 3, wherein the plurality of light emitting elements which light at the same timing are electrically connected in series with respect to the lighting unit.

5. The illumination apparatus according to claim 1, wherein
the current supply unit is configured to supply a current larger than a maximum current permitted when the light emitting element is direct-current lighted, and
the number of the plurality of light emitting elements, and a lighting period in which the lighting unit lights the light emitting elements are set in such a manner that an average power is smaller than the maximum power permitted for the light emitting element.

6. The illumination apparatus according to claim 1, further comprising: a light power control unit configured to adjust the current of the current supply unit,
wherein the light power control unit is controlled by the timing control unit.

7. The illumination apparatus according to claim 6, wherein the light power control unit is configured to adjust the current of the current supply unit in a period shorter than a lighting period in which the lighting unit continuously lights one light emitting element.

8. The illumination apparatus according to claim 6, wherein the plurality of light emitting elements include a plurality of types of light emitting elements having different emitted light colors, and
are connected to a plurality of types of power supplies in accordance with the types.

9. The illumination apparatus according to claim 1, wherein the plurality of light emitting elements include a plurality of types of light emitting elements having different emitted light colors, and
are connected to a plurality of types of power supplies in accordance with the types.

10. The illumination apparatus according to claim 1, wherein
the current supply unit, the lighting unit, and the plurality of light emitting elements which are mutually connected constitute one series,
the apparatus comprising a plurality of series.

11. The illumination apparatus according to claim 10, wherein the light emitting elements belonging to different series among the plurality of series are disposed adjacent to one another.

12. The illumination apparatus according to claim 11, wherein
the timing control unit is configured to control the lighting units of the plurality of series, and
the lighting unit of each series is configured to sequentially light the light emitting elements belonging to each series every predetermined number of the elements in such a manner that lighting periods of the light emitting elements disposed adjacent to each other overlap with each other.

13. The illumination apparatus according to claim 10, wherein
the plurality of series have the same emitted light color of the plurality of light emitting elements belonging to the same series, and
the apparatus having a plurality of types of series having different emitted light colors.

14. A display apparatus comprising:
an illumination apparatus which illuminates an illumination object region, including:
a current supply unit configured to supply a current controlled into a predetermined value;
a plurality of light emitting elements configured to generate light in response to the supplied current;
a lighting unit configured to distribute the current supplied by the current supply unit to a predetermined number of the light emitting elements among the plurality of light emitting elements, so that the light emitting elements are lighted;
a light guide unit having a light take-in portion, configured to relatively move the light take-in portion with respect to the light emitting elements, and configured to guide the light taken in by the light take-in portion to the illumination object region; and
a timing control unit configured to control the lighting unit in synchronization with movement of the light take-in portion of the light guide unit, the lighting unit being configured to sequentially light the light emitting elements positioned in the vicinity of the light take-in portion of the light guide unit every predetermined number of the elements based on control by the timing control unit; and
a spatial light modulation unit which is disposed in the illumination object region and to which illumination light from the illumination apparatus is applied,
wherein the display apparatus displays an image by modulated light modulated by the spatial light modulation unit.

15. The display apparatus according to claim 14, wherein
the spatial light modulation unit includes a spatial light modulation element configured to modulate a pulse width of the illumination light applied from the illumination apparatus to thereby represent gradation of the modulated light, and
the light power control unit is configured to adjust the current of the current supply unit in a period shorter than a lighting period in which one light emitting element continuously lights and to control the light power of the illumination light to be substantially constant.

16. The display apparatus according to claim 14, wherein
the plurality of light emitting elements are arranged on a circumference, and
the light take-in portion of the light guide unit is configured to relatively rotate and move along the circumference.

17. The display apparatus according to claim 14, wherein
the light guide unit has a plurality of light take-in portions,
the number of the light emitting elements lighted at the same timing by the lighting unit is equal to that of the plurality of light take-in portions, and
the timing control unit is configured to control the plurality of light emitting elements in such a manner as to light them at the same timing in synchronization with movement of the plurality of light take-in portions.

18. The display apparatus according to claim 17, wherein the plurality of light emitting elements which light at the same timing are electrically connected in series with respect to the lighting unit.

19. The display apparatus according to claim 14, wherein
the current supply unit is configured to supply a current larger than a maximum current permitted when the light emitting element is direct-current lighted, and
the number of the plurality of light emitting elements, and a lighting period in which the lighting unit lights the light emitting elements are set in such a manner that an average power is smaller than the maximum power permitted for the light emitting element.

20. The display apparatus according to claim 14, further comprising: a light power control unit configured to adjust the current of the current supply unit,
wherein the light power control unit is controlled by the timing control unit.

21. The display apparatus according to claim 20, wherein the light power control unit is configured to adjust the current of the current supply unit in a period shorter than a lighting period in which the lighting unit continuously lights one light emitting element.

22. The display apparatus according to claim 20, wherein the plurality of light emitting elements include a plurality of types of light emitting elements having different emitted light colors, and
are connected to a plurality of types of power supplies in accordance with the types.

23. The display apparatus according to claim 14, wherein the plurality of light emitting elements include a plurality of types of light emitting elements having different emitted light colors, and
are connected to a plurality of types of power supplies in accordance with the types.

24. The display apparatus according to claim 14, wherein
the current supply unit, the lighting unit, and the plurality of light emitting elements which are mutually connected constitute one series,
the apparatus comprising a plurality of series.

25. The display apparatus according to claim 24, wherein the light emitting elements belonging to different series among the plurality of series are disposed adjacent to one another.

26. The display apparatus according to claim 25, wherein
the timing control unit is configured to control the lighting units of the plurality of series, and
the lighting unit of each series is configured to sequentially light the light emitting elements belonging to each series every predetermined number of the elements in such a manner that lighting periods of the light emitting elements disposed adjacent to each other overlap with each other.

27. The display apparatus according to claim 24, wherein
the plurality of series have the same emitted light color of the plurality of light emitting elements belonging to the same series, and
the apparatus having a plurality of types of series having different emitted light colors.

28. An illumination apparatus which illuminates an illumination object region, comprising:
current supply means for supplying a current controlled into a predetermined value;
a plurality of light emitting elements for generating light in response to the supplied current;
lighting means for distributing the current supplied by the current supply means to a predetermined number of the light emitting elements among the plurality of light emitting elements so that the light emitting elements are lighted;
light guide means, having a light take-in portion, for relatively moving the light take-in portion with respect to the light emitting elements, and for guiding the light taken in by the light take-in portion to the illumination object region; and
timing control means for controlling the lighting means in synchronization with movement of the light take-in portion of the light guide means,
wherein the lighting means sequentially light the light emitting elements positioned in the vicinity of the light take-in portion of the light guide means every predetermined number of the elements based on control by the timing control means.

29. A display apparatus comprising:
an illumination apparatus which illuminates an illumination object region, including:
current supply means for supplying a current controlled into a predetermined value;
a plurality of light emitting elements for generating light in response to the supplied current;
lighting means for distributing the current supplied by the current supply means to a predetermined number of the light emitting elements among the plurality of light emitting elements so that the light emitting elements are lighted;
light guide means, having a light take-in portion, for relatively moving the light take-in portion with respect to the light emitting elements, and for guiding the light taken in by the light take-in portion to the illumination object region; and
timing control means for controlling the lighting means in synchronization with movement of the light take-in portion of the light guide means, the lighting means sequentially lighting the light emitting elements positioned in the vicinity of the light take-in portion of the light guide means every predetermined number of the elements based on control by the timing control means; and
spatial light modulation means which is disposed in the illumination object region and to which illumination light from the illumination apparatus is applied,
wherein the display apparatus displays an image by modulated light modulated by the spatial light modulation means.
